(19) United States
(12) Patent Application Publication
(10) Pub. No.: US 2009/0247698 A1
(43) Pub. Date: Oct. 1, 2009

(54) Method for esterification of polyvinyl alcohol-based resin, resultant modified polyvinyl alcohol-based resin, and method for production of the same

(76) Inventor: Daisuke Nitta, Sakai-shi (JP)

Correspondence Address: WENDEROTH, LIND & PONACK, L.L.P., 1030 15th Street, N.W.,, Suite 400 East, Washington, DC, 20005-1503, US

(21) Appl. No.: 11/990,768

(22) PCT Filed: Aug. 21, 2006
(86) PCT No.: PCT/JP2006/316314

§ 371 Date: Feb. 21, 2008

(30) Foreign Application Priority Data
Aug. 22, 2005 (JP) 2005-239435

(51) Int. Cl. C08G 63/91

(52) U.S. Cl. 525/61

(57) ABSTRACT

A gist of the present invention lies in a method for esterification of a polyvinyl alcohol-based resin, wherein a vinyl ester is used as an esterifying agent in a method for esterification of a polyvinyl alcohol-based resin by an esterification reaction using an esterifying agent. The esterification method can esterify the polyvinyl alcohol-based resin at a high reaction rate under mild reaction conditions using relatively simple reaction equipment, and is also applicable to a wide variety of polyvinyl alcohol-based resins without being restricted by polymerization and saponification degrees of the polyvinyl alcohol-based resin. Thus, it is possible to provide a modified polyvinyl alcohol-based resin having excellent physical properties such as polymerization and modification degrees, which is applicable to various applications.

### TECHNICAL FIELD

The present invention relates to a method for esterification of a polyvinyl alcohol-based resin, particularly an esterification method of a polyvinyl alcohol-based resin using an esterifying agent for post-modification, and also relates to a modified polyvinyl alcohol-based resin obtained by the esterification method.

### BACKGROUND ART

Known methods for introduction of an ester group into a polyvinyl alcohol-based resin include a post-modification method in which a hydroxyl group in a polyvinyl alcohol-based resin is reacted with an ester compound of carboxylic acid having 1 to 22 carbon atom(s) and a polyhydric alcohol (see Japanese Patent Application Laid-Open (JP-A) No. 2001-72710, page 2, Claim 1), an organic acid anhydride (see JP-A No. 2000-239317, page 2, Claim 1 and JP-A No. 2003-4729, page2, Claim 1) and a carboxylic acid halide having a halogenated alkyl (see JP-A No. Hei5-345116, page 2, Claim 3), or a method in which vinyl ester as a copolymerized monomer is added at once or by several portions in a polymerization process of vinyl acetate as a raw material of a polyvinyl alcohol resin, followed by copolymerization and further a saponification process (see JP-A No. Sho55-94978, page 1, Claim (1)).

### DISCLOSURE OF THE INVENTION

### Problems to be Solved by the Invention

As mentioned above, the known methods for introduction of an ester group into a polyvinyl alcohol-based resin include a post-modification method in which an esterifying agent such as an alkyl ester, a carboxylic acid anhydride or a carboxylic acid halide is reacted with a hydroxyl group in the polyvinyl alcohol-based resin, or a method in which a polymer obtained by binary copolymerization of a vinyl ester monomer and a vinyl acetate monomer is saponified with sodium hydroxide or the like.

Problems of these methods are as follows. That is, in the former post-modification method, a transesterification reaction using an alkyl ester such as a methyl ester (methyl palmitate, methyl stearate or the like) as the esterifying agent raises the reaction rate that exceeds the equilibrium state, which requires an operation to remove the resultant alcohol (methyl alcohol in the case of a methyl ester) outside the reaction system, resulting in the complication of the reaction apparatus and operation.

On the other hand, in the latter method through binary copolymerization of a vinyl ester monomer and a vinyl acetate monomer, in the case of a vinyl ester having reactive double bonds (vinyl acrylate, vinyl methacrylate, vinyl crotonate, vinyl cinnamate, vinyl para-methoxycinnamate or the like), partial ternary copolymerization with the reactive double bonds occurs, and it becomes difficult or impossible to obtain a polymer with a predetermined polymerization or modification degree. Some cases may be coped just with accepting reduction of the modification degree or the reactivity, but they still are of disadvantage from an economical standpoint. Even if a polymer with a predetermined polymerization or modification degree is obtained, some or most of the ester groups introduced upon polymerization may be eliminated in the saponification process later on, and thus the cost problem becomes more serious.

An object of the present invention is to provide a novel method for esterification of a polyvinyl alcohol-based resin, which can esterify a polyvinyl alcohol-based resin at a high reaction rate under mild reaction conditions using comparatively simple reaction equipment, and also which is applicable to a wide variety of polyvinyl alcohol-based resins without being limited by polymerization and saponification degrees of the polyvinyl alcohol-based resin. Another object of the present invention is to provide a modified polyvinyl alcohol-based resin having excellent physical properties such as polymerization and modification degrees, which is applicable to various applications.

### Means for Solving the Problems

The present inventors have intensively studied so as to achieve the above objects and found that a modified polyvinyl alcohol-based resin having required excellent physical properties such as polymerization and modification degrees can be obtained at a high reaction rate using a vinyl ester as an esterifying agent when an esterification reaction is carried out for post-modification of the polyvinyl alcohol-based resin. They have further studied and thus the present invention has been completed.

That is, the present invention relates to:

(1) A method for esterification of a polyvinyl alcohol-based resin by an esterification reaction using an esterifying agent, wherein a vinyl ester is used as the esterifying agent;
(2) The method for esterification of a polyvinyl alcohol-based resin according to the above-mentioned (1), wherein an aprotic polar solvent is used as a solvent in the reaction;
(3) The method for esterification of a polyvinyl alcohol-based resin according to the above-mentioned (2), wherein the polyvinyl alcohol-based resin is completely dissolved in the aprotic polar solvent in the reaction;
(4) The method for esterification of a polyvinyl alcohol-based resin according to the above-mentioned (1) or (2), wherein an alkali metal compound is used as an esterifying catalyst in the reaction;
(5) The method for esterification of a polyvinyl alcohol-based resin according to the above-mentioned (1) or (2), wherein sodium acetate which is preliminarily contained in the polyvinyl alcohol-based resin is used as an esterifying catalyst in the reaction;
(6) A modified polyvinyl alcohol-based resin obtained by the esterification method according to any one of the above-mentioned (1) to (5); and
(7) A method for production of a modified polyvinyl alcohol-based resin from a polyvinyl alcohol-based resin by an esterification reaction using an esterifying agent, wherein a vinyl ester is used as the esterifying agent.

### Effects of the Invention

According to the esterification method of the present invention, esterification of a polyvinyl alcohol-based resin is carried out at a high reaction rate under mild reaction conditions using comparatively simple reaction equipment. Further, the esterification method of the present invention is applicable to esterification of a wide variety of polyvinyl alcohol-based resins without being limited by polymerization and saponification degrees of the polyvinyl alcohol-based resin to be esterified.

In addition, the modified polyvinyl alcohol-based resin of the present invention is excellent in physical properties such as polymerization and modification degrees, and is therefore applicable to various applications.

The method for production of a modified polyvinyl alcohol-based resin of the present invention enables production of the above modified polyvinyl alcohol-based resin in a simple manner with high productivity using various polyvinyl alcohol-based resins as raw materials without being limited by polymerization and saponification degrees.

### BEST MODE FOR CARRYING OUT THE INVENTION

The present invention will now be described in detail.

In the present invention, the polyvinyl alcohol-based resin to be esterified in the esterification reaction is not particularly limited, and a wide variety of polyvinyl alcohol-based resins can be used.

In the present invention, therefore, a polyvinyl alcohol-based resin prepared from various vinyl ester monomers as raw materials can be used. The vinyl ester monomers as the raw materials for the polyvinyl alcohol-based resin are not particularly limited. Examples thereof include vinyl acetate, vinyl formate, vinyl propionate, vinyl butyrate, vinyl pivalate and the like. Among these monomers, vinyl acetate is preferable from an industrial point of view.

The polyvinyl alcohol-based resin used in the present invention may be those with which unsaturated monomers that are copolymerizable with vinyl ester monomers are copolymerized, as long as the effect of the present invention is not impaired. Examples of unsaturated monomers that are copolymerizable with vinyl ester monomers include, but are not limited to, unsaturated dibasic acid monoalkyl esters such as monomethyl maleate and monomethyl itaconate; amide group-containing monomers such as diacetone acrylamide, acrylamide, dimethyl acrylamide, N-methylol acrylamide and N-vinyl-2-pyrrolidone; alkyl vinyl ethers such as lauryl vinyl ether and stearyl vinyl ether; hydroxyl group-containing monomers such as allyl alcohol, dimethyl allyl alcohol and isopropenyl allyl alcohol; acetyl group-containing monomers such as allyl acetate, dimethyl allyl acetate and isopropenyl allyl acetate; vinyl halides such as vinyl chloride, vinylidene chloride and vinyl fluoride; vinyl silanes such as trimethoxy vinyl silane, tributyl vinyl silane and diphenyl methyl vinyl silane; alpha-olefins such as ethylene and propylene; sulfone group-containing monomers such as sodium allyl sulfonate, sodium methallyl sulfonate and sodium styrene sulfonate; acrylic acid-based monomers such as acrylic acid, methacrylic acid, 2-ethylhexyl acrylate, n-butyl acrylate, and 2-(2′-hydroxy-5′-methacryloxyethylphenyl)-2H-benzotriazole; and oxyalkylene group-containing monomers such as polyoxyethylene (meth)acrylate, polyoxypropylene (meth)acrylate, polyoxyethylene (meth)acrylic acid amide, polyoxypropylene (meth)acrylic acid amide, polyoxyethylene (meth)allyl ether, polyoxypropylene (meth)allyl ether, polyoxyethylene vinyl ether and polyoxypropylene vinyl ether, and the like.

The polyvinyl alcohol-based resin used in the present invention may be produced according to a conventional method. The method for production of the polyvinyl alcohol-based resin includes bulk, solution, suspension and emulsification polymerization methods. Among these methods, a method of polymerizing in a solvent such as methyl alcohol using an azo-based or peroxide-based initiator such as α,α′-azobisisobutylonitrile, 2,2′-azobis(2,4-dimethylbaleronitrile), peracetic acid or di-n-propylperoxydicarbonate is usually used. A chain transfer agent such as 2-mercapto ethanol may be used for the polymerization so as to adjust the polymerization degree, or a polymerization inhibitor/depressant such as hydroquinone, 4-hydroxy-2,2,6,6-tetramethylpiperidine-1-oxyl or meta-dinitrobenzene, or the like may be used. The known methods are also applicable to removal of non-reacted monomers, saponification, drying and grinding methods without any particular restrictions. For example, a vinyl ester polymer or copolymer obtained in the above polymerization method is dissolved in an aprotic polar solvent such as dimethyl sulfoxide, removal of non-reacted monomers and saponification are carried out, and the resultant polyvinyl alcohol solution may be served for an esterification reaction as it is. In this case, washing, drying and grinding processes which are necessary in a conventional method for production of the polyvinyl alcohol-based resin, and a dissolving process of a usual polyvinyl alcohol resin before serving it for an esterification reaction can be omitted. Thus the process is advantageous in view of productivity and cost effectiveness.

The saponification and polymerization degrees of the polyvinyl alcohol-based resin used in the present invention are not particularly limited and may be selected freely according to the purposes and applications.

In the present invention, the polyvinyl alcohol-based resin may be used alone or in combination of two or more kinds. For example, one or more than two kind(s) of the polyvinyl alcohol-based resin obtained in the above method can be used.

In the present invention, the polyvinyl alcohol-based resin is esterified by the esterification reaction using an esterifying agent, and it is important to use a vinyl ester as the esterifying agent. Since the transesterification reaction is an equilibrium reaction in general, in esterification of the polyvinyl alcohol-based resin using carboxylic acid ester as the esterifying agent, a method is employed in which a by-produced alcohol to be eliminated is taken out of the system by a reaction distillation device in order to obtain an objective compound efficiently. As a result, the plant cost is high, and the operation is complex. In contrast, in the present invention in which a vinyl ester is used as the esterifying agent, vinyl alcohol to be eliminated upon esterification reaction immediately turns into acetaldehyde, being a chemically stable isomer which does not contribute to the equilibrium reaction and also has a low boiling point. This makes it easier to be removed outside the system. The method of the present invention is, therefore, excellent in view of a high reaction rate in the esterification reaction for producing the objective compound and is advantageous in view of cost and operability, as compared with the methods using an esterifying agent other than the vinyl ester.

Examples of the vinyl ester used as the esterifying agent for the polyvinyl alcohol-based resin in the present invention include vinyl esters of organic carboxylic acids, and examples of the organic carboxylic acids include aliphatic carboxylic acids and aromatic carboxylic acids. The aliphatic carboxylic acid may be a saturated or unsaturated carboxylic acid, and any of linear, branched or cyclic ones. Further, these carboxylic acids may have substituents such as an alkyl group, an alkoxy group, a halogen atom, a hydroxyl group, an aryl group, an amino group, or a substituted amino group in the molecule.

Specific examples of the vinyl ester include, but are not limited to, vinyl monochloroacetate, vinyl pivalate, vinyl butylate, vinyl caproate, vinyl laurate, vinyl benzoate, vinyl stearate, vinyl cinnamate, vinyl octylate, vinyl propionate, vinyl caprylate, vinyl caprate, vinyl myristate, vinyl palmitate, vinyl para-t-butylbenzoate, divinyl adipate, vinyl methacrylate, vinyl crotonate, vinyl sorbate, vinyl undecylate, vinyl para-dimethylaminobenzoate, vinyl para-methoxycinnamate, vinyl 2,2-dimethylpentanoate, vinyl 2,2-dimethylbutanoate, vinyl 2-ethyl-2-methylbutanoate, vinyl neodecanoate, vinyl acrylate, vinyl meta-methoxybenzoate, vinyl p-methylbenzoate, vinyl para-hydroxybenzoate, vinyl acetate, vinyl isobutylate, vinyl cyclohexane carboxylate, vinyl 1-naphthoate, vinyl 2-naphthoate, vinyl monobromoacetate, vinyl biphenyl-4-carboxylate, vinyl valerate, vinyl isovalerate, vinyl 2-methylbutylate, monovinyl adipate, vinyl meta-hydroxybenzoate, divinyl sebacate, vinyl methylsebacate, vinyl para-t-butylcyclohexane carboxylate, vinyl behenate and the like.

The vinyl esters can be used alone or in combination of two or more kinds. The amount of the vinyl ester to be used as the esterifying agent is not particularly limited, and can be properly adjusted according to the reactivity of the vinyl ester and the reaction conditions. For example, the vinyl ester can be used as the esterifying agent in a 1.0- to 2.5-fold amount, and preferably from 1.1- to 1.5-fold amount, of the required esterification degree.

The esterification reaction method in the present invention is not particularly limited as long as the above esterifying agent is used. The method can be selected freely according to the required properties of the objective compound of the esterification reaction, or modified polyvinyl alcohol-based resin. For example, homogeneous and heterogeneous reaction methods as described below are exemplified.

The homogeneous reaction method can be carried out by dissolving the polyvinyl alcohol-based resin in an aprotic polar solvent such as dimethyl sulfoxide (DMSO), followed by the addition of an esterifying agent. It is a preferable method when a highly esterified (e.g., not less than 10 mol %) modified polyvinyl alcohol-based resin is obtained.

An example of a heterogeneous reaction method includes a solid-liquid heterogeneous reaction method, in which the esterification can be carried out, for example, by adding an esterifying agent in a lump or dividing while the polyvinyl alcohol-based resin is dispersed in a vinyl ester serving as the esterifying agent or in a solvent used for the esterification reaction (e.g., dimethylformamide), or while the solid or semisolid polyvinyl alcohol-based resin is stirred with a kneader or the like. The solid-liquid heterogeneous reaction method is preferred when a part of the polyvinyl alcohol-based resin is esterified.

In the solid-liquid heterogeneous reaction method, an aprotic polar solvent such as DMSO may be added in an adequate amount, thereby swelling the particle surface of the polyvinyl alcohol-based resin and increasing the reaction efficiency.

Regardless of whether the system is homogeneous or heterogeneous, the above reaction methods require no special reaction equipment. Accordingly, known reaction equipment can be used for the esterification reaction of the present invention, and a general device equipped with a temperature controller, a stirrer and a reflux condenser is satisfactory. When vinyl monochloroacetate is used, it is preferable to use a material whose quality is equivalent to SUS316 for the parts with which vinyl monochloroacetate contacts.

It is preferred that the esterification reaction of the present invention is carried out in the presence of an esterifying catalyst. The esterifying catalyst is not particularly limited, and known esterifying catalysts can be used. Examples of the esterifying catalyst include metal compounds such as alkali metal, zirconium, hafnium, titanium and tin compounds, lipase and the like. Among these compounds, alkali metal compounds are preferred.

More preferred esterifying catalyst is sodium acetate contained preliminarily in the polyvinyl alcohol-based resin in view of reaction rate and economy. When sodium acetate contained preliminarily in the polyvinyl alcohol-based resin is used as the esterifying catalyst, the content of the sodium acetate in the polyvinyl alcohol-based resin is preferably not less than 0.1% by weight, and more preferably from 0.5 to 1.0% by weight. However, when the content is less than 0.1% by weight, or when the reaction speed is intended to increase, sodium acetate can be added afterward according to need.

In the present invention, an aprotic polar solvent is preferred as a solvent for the esterification reaction (hereafter called a “reaction solvent”). The aprotic polar solvent as a reaction solvent is not limited as long as the solubility of the polyvinyl alcohol-based resin or of a vinyl ester as the esterifying agent to the solvent is high, but preferably an aprotic polar solvent in which the solubility of both the polyvinyl alcohol-based resin and a vinyl ester to the solvent is high in view of the reaction efficiency. Specifically, DMSO is particularly preferred. The use of the aprotic polar solvent such as DMSO, whose solubility to either of the above components is high, allows the polyvinyl alcohol-based resin to be completely dissolved, and enables the homogeneous reaction method that is briefly described above.

Incidentally, the reaction solvent in the present invention may not necessarily be an aprotic polar solvent. Even when the reaction system is heterogeneous, wherein the polyvinyl alcohol-based resin is not dissolved in a solvent because of the polymerization or saponification degree thereof or the type of the reaction solvent, the esterification reaction can sufficiently proceed if the conditions satisfy that the polyvinyl alcohol-based resin is contacted with a vinyl ester serving as the esterifying agent by means of stirring or the like.

The amount of the reaction solvent to be used is not particularly limited and may be properly adjusted in accordance with the known esterification reaction. The vinyl ester serving as the esterifying agent may also play a role of a reaction solvent.

A preferred method to carry out the esterification reaction in the present invention will be described in more detail: the polyvinyl alcohol-based resin containing sodium acetate and an aprotic polar solvent such as DMSO are placed in a proper reactor vessel and heated and stirred until the resin is dissolved or dispersed, or more preferably until it is completely dissolved; the reaction catalyst is additionally placed if necessary; a vinyl ester as the esterifying agent is added in a predetermined amount under a predetermined reaction temperature maintained so as to initiate the reaction; and the reaction is terminated after a predetermined reaction time passes.

The reaction temperature of the esterification reaction may be generally approximately from 30 to 120° C., and preferably from 40 to 100° C., regardless of whether the system is homogeneous or heterogeneous, although it may vary according to other conditions. The reaction time of the esterification reaction may be generally approximately from 1 to 24 hours, although it may vary according to the reactivity of a vinyl ester as the esterifying agent and an objective reaction rate. In this range, the esterification reaction can proceed satisfactorily.

The esterification method of the polyvinyl alcohol-based resin of the present invention is carried out by the esterification method explained above, and as a result, a modified polyvinyl alcohol-based resin is obtained. The modified polyvinyl alcohol-based resin obtained by the esterification reaction of the present invention is one of the aspects of the present invention. In the present invention, the modified polyvinyl alcohol-based resin can be prepared from the polyvinyl alcohol-based resin through the esterification reaction using a vinyl ester as the above esterifying agent, and this provides a novel production method for a modified polyvinyl alcohol-based resin. The production method is also one of the aspects of the present invention.

A method of taking out the modified polyvinyl alcohol-based resin after completion of the esterification reaction is not particularly limited, and can be carried out according to known methods.

In the case of a homogeneous system where the esterification reaction is carried out using a DMSO solution of the polyvinyl alcohol-based resin, a solid resin product is obtained such that the modified polyvinyl alcohol-based resin is deposited from a solution after reaction (reaction solution) through a reprecipitation treatment using a poor solvent such as methyl alcohol, acetone, methyl acetate or ethyl acetate. At this time, a slurry making method by simultaneously conducting mixing of the reaction solution with the poor solvent and disconnection of the deposited resin using a mixer (e.g., a high shear mixer manufactured by SILVERSON), or a method by a wet and dry spinning device can be employed. Pulverization by a spray dry method, a casting method or a film formation method by extrusion using a die or the like can also be employed. In the case of slurry making, for example, purification of the deposited resin composition may include separation of the resultant slurry by a centrifugal filter or the like, washing of the resultant solid with an organic solvent such as acetone or methyl alcohol if necessary, drying with a constant temperature oven or the like, and powdering with a grinder as required.

When the esterification reaction is a solid-liquid heterogeneous system, for example, the modified polyvinyl alcohol-based resin is separated after the reaction using a centrifugal filter or the like, and the operations such as washing, drying and/or grinding may be implemented according to need.

In the present invention, proper selection of a vinyl ester serving as the esterifying agent provides various properties to the modified polyvinyl alcohol-based resin of the present invention, and this enables acquisition of the modified polyvinyl alcohol-based resin that is applicable to various usages.

The modified polyvinyl alcohol-based resin obtained by esterification of a vinyl ester having a long chain alkyl group, such as vinyl stearate or vinyl laurate, has internal plasticization, so that applications to melt molding and the like are expected. According to the modification degree, a highly viscous modified polyvinyl alcohol-based resin provided with thixotropic properties can be obtained.

The modified polyvinyl alcohol-based resin obtained by esterification of a vinyl ester having a reactive double bond, such as vinyl acrylate, vinyl methacrylate, vinyl crotonate, vinyl cinnamate or vinyl p-methoxycinnamate, can be gelatinized by adding a thermal polymerization initiator such as ammonium persulfate to the aqueous resin solution. The gelatinized resin can be used as a hydrated gel. When a photopolymerization initiator (e.g., IRGACURE754 manufactured by Ciba Specialty Chemicals) or the like is added, the modified polyvinyl alcohol-based resin can be used for the applications as photosensitive resins (e.g., photoresists and UV-cured paints).

### EXAMPLES

The present invention will now be described in more detail by way of Examples. However, the present invention is not limited to the following Examples.

In Examples 1, 6 and 12, and Comparative Example 1, the esterification degree was measured in accordance with JIS K-6726 (saponification degree). That is, the amount of the acetic acid group m₁ (mol %) of the resin before the esterification reaction and the amount of the acetic acid group m₂ (mol %) of the resin after the esterification reaction were measured, respectively, and then the value obtained by subtracting m₁ from m₂ was defined as the esterification degree.

The esterification degree obtained in Example 8 (vinyl monochloroacetate was used as the esterifying agent) was calculated from the value of total chlorine analyzed by chlorine analysis equipment (TS-300CL type) manufactured by DIA INSTRUMENTS.

The esterification degrees in Examples 2 to 5, Example 7 and Examples 9 to 11 were determined by a simplified method, which includes measuring the amount of the vinyl ester used as the esterifying agent remaining in the reaction solution immediately after the esterification reaction using gas chromatography (GC-14B manufactured by Shimadzu Corporation), and calculating the esterification degree from the amount of the vinyl ester to be consumed.

### Example 1

50 g of polyvinyl alcohol (polymerization degree 1,700, saponification degree 99.5 mol %, content of sodium acetate 0.5 wt %) and 450 g of DMSO were placed in a 1,000 ml three-neck round bottom flask equipped with a stirrer and a reflux condenser, and heated and stirred at 70° C. to dissolve the polyvinyl alcohol completely. Then, 9.7 g of vinyl acetate (equivalent to 10.0 mol % of polyvinyl alcohol) was added thereto as the esterifying agent at the reaction temperature of 65° C. to initiate the esterification reaction. The reaction solution was collected 1 hour and 30 hours after the addition of the esterifying agent, and solid resin products were obtained from the respective reaction solutions through a reprecipitation method in an acetone bath. The respective solid resin products were further washed with methyl alcohol for 24 hours using a Soxhlet extraction device, the solvent was dried off with a constant temperature oven (steam heat source type), and the remaining solid resin products were ground with a table mill to give powdered resins as modified polyvinyl alcohol-based resins, respectively. Then, the esterification degrees of the respective modified polyvinyl alcohol-based resins were measured. The esterification degree of the resin obtained from the reaction solution 1 hour after the addition of the esterifying agent was 9.2 mol %, while that of the resin obtained from the reaction solution 30 hours after the addition of the esterifying agent was 9.6 mol % (see Table 1).

### Example 2

50 g of polyvinyl alcohol (polymerization degree 4,500, saponification degree 92.3 mol %, content of sodium acetate 0.5 wt %) and 450 g of DMSO were placed in a 1,000 ml three-neck round bottom flask equipped with a stirrer and a reflux condenser, and heated and stirred at 70° C. to dissolve the polyvinyl alcohol completely. Then, 118.5 g of vinyl acetate (equivalent to 130 mol % of polyvinyl alcohol) was added thereto as the esterifying agent at the reaction temperature of 70° C. to initiate the esterification reaction. The reaction was terminated after 48 hours. The esterification degree of the collected reaction solution was calculated from the analytical value by gas chromatography to give 94.2 mol % (see Table 1).

### Example 3

20 g of polyvinyl alcohol (polymerization degree 1,700, saponification degree 99.5 mol %, content of sodium acetate 0.5 wt %) and 180 g of DMSO were placed in a 1,000 ml three-neck round bottom flask equipped with a stirrer and a reflux condenser, and heated and stirred at 70° C. to dissolve the polyvinyl alcohol completely. Then, 15.5 g of vinyl butyrate (equivalent to 30.0 mol % of polyvinyl alcohol) was added thereto as the esterifying agent at the reaction temperature of 65° C. to initiate the esterification reaction. The reaction was terminated after 24 hours. The esterification degree of the collected reaction solution was calculated from the analytical value by gas chromatography to give 27.9 mol % (see Table 1).

### Example 4

20 g of polyvinyl alcohol (polymerization degree 550, saponification degree 98.5 mol %, content of sodium acetate 1.0 wt %) and 180 g of DMSO were placed in a 500 ml three-neck round bottom flask equipped with a stirrer and a reflux condenser, and heated and stirred at 70° C. to dissolve the polyvinyl alcohol completely. Then, 0.5 g of vinyl laurate (equivalent to 0.5 mol % of polyvinyl alcohol) was added thereto as the esterifying agent at the reaction temperature of 60° C. to initiate the esterification reaction. The reaction was terminated after 14 hours. The esterification degree of the collected reaction solution was calculated from the analytical value by gas chromatography to give 0.3 mol % (see Table 1).

### Example 5

20 g of polyvinyl alcohol (polymerization degree 550, saponification degree 98.5 mol % content of sodium acetate 1.0 wt %) and 180 g of DMSO were placed in a 500 ml three-neck round bottom flask equipped with a stirrer and a reflux condenser, and heated and stirred at 70° C. to dissolve the polyvinyl alcohol completely. Then, 131.9 g of vinyl laurate (equivalent to 130 mol % of polyvinyl alcohol) was added thereto as the esterifying agent at the reaction temperature of 70° C. to initiate the esterification reaction. The reaction was terminated after 48 hours. The esterification degree of the collected reaction solution was calculated from the analytical value by gas chromatography to give 58.6 mol % (see Table 1).

### Example 6

50 g of polyvinyl alcohol (polymerization degree 560, saponification degree 98.3 mol %, content of sodium acetate 0.8 wt %) and 450 g of DMSO were placed in a 1,000 ml three-neck round bottom flask equipped with a stirrer and a reflux condenser, and heated and stirred at 70° C. to dissolve the polyvinyl alcohol completely. Then, 3.8 g of vinyl methacrylate (equivalent to 3.0 mol % of polyvinyl alcohol) was added thereto as the esterifying agent at the reaction temperature of 50° C. to initiate the esterification reaction. The reaction was terminated after 8 hours, and a solid resin product was obtained from the collected reaction solution through a reprecipitation method in an acetone bath. The product was further washed with methyl alcohol for 24 hours using a Soxhlet extraction device, the solvent was dried off with a constant temperature oven (steam heat source type), and the remaining solid resin product was ground with a table mill to give a powdered resin as a modified polyvinyl alcohol-based resin. The esterification degree of the resultant modified polyvinyl alcohol-based resin was measured to be 2.6 mol % (see Table 1). A follow-up study was conducted on the modified polyvinyl alcohol-based resin as follows.

### Follow-Up Study of Example 6

The infrared absorption spectrum of the modified polyvinyl alcohol-based resin obtained in Example 6 was measured with a Fourier transform infrared spectrophotometer (MAGNA-IR560) manufactured by NICOLET. An increase in the absorption at 1,710 cm⁻¹ (carbonyl group derived from ester) and the absorption at 1,635 cm⁻¹ (unsaturated carbon bond) were confirmed from the resultant infrared absorption spectrum. Then, the modified polyvinyl alcohol-based resin was dissolved in hot water to prepare a 10% aqueous solution, to which 1% by weigh of potassium persulfate (polymerization initiator) was added. When the aqueous solution was heated, gelatinization proceeded, which confirmed the existence of reactive double bonds in the modified polyvinyl alcohol-based resin. With the fact confirmed, it can be seen that the modified polyvinyl alcohol-based resin obtained in Example 6 by the method of the present invention had reactive double bonds and slight vinylation took place by the esterification.

### Example 7

20 g of polyvinyl alcohol (polymerization degree 160, saponification degree 65.0 mol %, content of sodium acetate 1.0 wt %) and 180 g of DMSO were placed in a 500 ml three-neck round bottom flask equipped with a stirrer and a reflux condenser, and heated and stirred at 70° C. to dissolve the polyvinyl alcohol completely. Then, 0.8 g of vinyl crotonate (equivalent to 2.0 mol % of polyvinyl alcohol) was added thereto as the esterifying agent at the reaction temperature of 50° C. to initiate the esterification reaction. The reaction was terminated after 8 hours. The esterification degree of the collected reaction solution was calculated from the analytical value by gas chromatography to give 1.7 mol % (see Table 1).

### Example 8

20 g of polyvinyl alcohol (polymerization degree 1,780, saponification degree 98.6 mol %, content of sodium acetate 0.6 wt %) and 180 g of DMSO were placed in a 500 ml three-neck round bottom flask equipped with a stirrer and a reflux condenser, and heated and stirred at 70° C. to dissolve the polyvinyl alcohol completely. Then, 8.1 g of vinyl monochloroacetate (equivalent to 15 mol % of polyvinyl alcohol) was added thereto as the esterifying agent at the reaction temperature of 65° C. to initiate the esterification reaction. The reaction was terminated after 14 hours, and a solid resin product was obtained from the collected reaction solution through a reprecipitation method in an acetone bath. The product was further washed with methyl alcohol for 24 hours using a Soxhlet extraction device, the solvent was dried off with a constant temperature oven (steam heat source type), and the remaining solid resin product was ground with a table mill to give a powdered resin as a modified polyvinyl alcohol-based resin. The esterification degree calculated from the total chlorine amount of the resultant modified polyvinyl alcohol-based resin was 12.7 mol % (see Table 1).

### Example 9

20 g of polyvinyl alcohol (polymerization degree 1,690, saponification degree 99.2 mol %, content of sodium acetate 0.5 wt %) and 180 g of DMSO were placed in a 500 ml three-neck round bottom flask equipped with a stirrer and a reflux condenser, and heated and stirred at 70° C. to dissolve the polyvinyl alcohol completely. Then, 2.8 g of vinyl para-t-butylbenzoate (equivalent to 3.0 mol % of polyvinyl alcohol) was added thereto as the esterifying agent at the reaction temperature of 65° C. to initiate the esterification reaction. The reaction was terminated after 8 hours. The esterification degree of the collected reaction solution was calculated from the analytical value by gas chromatography to give 1.6 mol % (see Table 1).

### Example 10

20 g of polyvinyl alcohol (polymerization degree 1,690, saponification degree 99.2 mol %, content of sodium acetate 0.5 wt %) and 180 g of DMSO were placed in a 500 ml three-neck round bottom flask equipped with a stirrer and a reflux condenser, and heated and stirred at 70° C. to dissolve the polyvinyl alcohol completely. Then, 8.7 g of vinyl pivalate (equivalent to 15.0 mol % of polyvinyl alcohol) was added thereto as the esterifying agent at the reaction temperature of 65° C. to initiate the esterification reaction. The reaction was terminated after 14 hours. The esterification degree of the collected reaction solution was calculated from the analytical value by gas chromatography to give 12.1 mol % (see Table 1).

### Example 11

20 g of polyvinyl alcohol (polymerization degree 1,690, saponification degree 99.2 mol %, content of sodium acetate 0.5 wt %) and 180 g of DMSO were placed in a 500 ml three-neck round bottom flask equipped with a stirrer and a reflux condenser, and heated and stirred at 70° C. to dissolve the polyvinyl alcohol completely. Then, 27.1 g of vinyl propionate (equivalent to 60.0 mol % of polyvinyl alcohol) was added thereto as the esterifying agent at the reaction temperature of 65° C. to initiate the esterification reaction. The reaction was terminated after 24 hours. The esterification degree of the collected reaction solution was calculated from the analytical value by gas chromatography to give 53.4 mol % (see Table 1).

### Example 12

The same operation as in Example 1 was carried out except for having used the polyvinyl alcohol which was washed in advance with methyl alcohol for 12 hours by a Soxhlet extraction device and was adjusted to have a sodium acetate content of 0.08% by weight as the substitute for the polyvinyl alcohol in Example 1. The esterification degrees of modified polyvinyl alcohol-based resins obtained by the respective reaction solutions 1 hour and 30 hours after the initiation of the esterification reaction were 0.8 mol % and 2.5 mol %, respectively (see Table 1).

### Comparative Example 1

The same operation as in Example 1 was carried out except for having added 41.9 g of methyl acetate (equivalent to 50.0 mol % of polyvinyl alcohol) as a substitute for 9.7 g of vinyl acetate in Example 1. Modified polyvinyl alcohol-based resins were obtained from the respective reaction solutions collected 1 hour and 30 hours after the addition of the esterifying agent. The esterification degree of the resin obtained from the reaction solution 1 hour after the addition of the esterifying agent was 0.6 mol %, while that of the resin obtained from the reaction solution 30 hours after the addition of the esterifying agent was 1.2 mol % (see Table 1).

### Comparative Example 2

The atmosphere in a reactor equipped with a stirrer, a reflux condenser, a nitrogen introduction tube, a thermometer and a pressure gauge was replaced with nitrogen. 2,800 g of a deoxidized vinyl acetate monomer and 1,000 g of methyl alcohol were placed in the reactor, and the temperature was raised under stirring. When the inside temperature became 60° C., a solution containing 1.5 g of α,α′-azobisisobutyronitrile dissolved in 50 g of methyl alcohol was added separately as a polymerization initiator and polymerization was initiated. Then, 100 g of a vinyl methacrylate monomer was continuously added. Halfway through, the polymerization was terminated since production of a gelatinous matter progressed.

Incidentally, the polyvinyl alcohol-based resins (polyvinyl alcohols), the esterifying agents (vinyl esters) and the amount of use thereof, the reaction temperatures, the reaction times, and the esterification degrees and the reaction rates attained as a result of the esterification reaction in Examples 1 to 12 and Comparative Example 1 are collectively shown in Table 1 below.

TABLE 1

| | PVA used | | | | | | | | |
|---|---|---|---|---|---|---|---|---|---|
| | Polymerization | Esterification reaction (Homogeneous system: 10% PVA solution in DMSO) | | | | | | | |
| | degree/Saponification | | | Reaction | Reaction | | Esterification | | Reaction |
| | degree/Sodium acetate | Esterifying agent (mol %/PVA) | | temperature | time | | degree | | rate |
| Example 1 | 1700/99.5 mol %/0.5% | Vinyl acetate | 10 | 65° C. | 1 | Hr | 9.2 | mol % | 92.0% |
| | | | | | 30 | Hr | 9.6 | mol % | 96.0% |
| Example 2 | 4500/92.3 mol %/0.5% | Vinyl acetate | 130 | 70° C. | 48 | Hr | 94.2 | mol % | 72.5% |
| Example 3 | 1700/99.5 mol %/0.5% | Vinyl butyrate | 30 | 65° C. | 24 | Hr | 27.9 | mol % | 93.0% |
| Example 4 | 550/98.5 mol %/1.0% | Vinyl laurate | 0.5 | 60° C. | 14 | Hr | 0.3 | mol % | 60.0% |
| Example 5 | 550/98.5 mol %/1.0% | Vinyl laurate | 130 | 70° C. | 48 | Hr | 58.6 | mol % | 45.1% |
| Example 6 | 560/98.3 mol %/0.8% | Vinyl methacrylate | 3 | 50° C. | 8 | Hr | 2.6 | mol % | 86.7% |
| Example 7 | 160/65.0 mol %/1.0% | Vinyl crotonate | 2 | 50° C. | 8 | Hr | 1.7 | mol % | 85.0% |
| Example 8 | 1780/98.6 mol %/0.6% | Vinyl monochloroacetate | 15 | 65° C. | 14 | Hr | 12.7 | mol % | 84.7% |
| Example 9 | 1690/99.2 mol %/0.5% | Vinyl para-t-butylbenzoate | 3 | 65° C. | 8 | Hr | 1.6 | mol % | 53.3% |
| Example 10 | 1690/99.2 mol %/0.5% | Vinyl monochloroacetate | 15 | 65° C. | 14 | Hr | 12.1 | mol % | 80.7% |
| Example 11 | 1690/99.2 mol %/0.5% | Vinyl propionate | 60 | 65° C. | 24 | Hr | 53.4 | mol % | 89.0% |
| Example 12 | 1700/99.5 mol %/0.08% | Vinyl acetate | 10 | 65° C. | 1 | Hr | 0.8 | mol % | 8.0% |
| | | | | | 30 | Hr | 2.5 | mol % | 25.0% |
| Comparative | 1700/99.5 mol %/0.5% | Methyl acetate | 50 | 65° C. | 1 | Hr | 0.6 | mol % | 1.2% |
| Example 1 | | | | | 30 | Hr | 1.2 | mol % | 2.4% |

PVA: Polyvinyl alcohol
Reaction rate (%) = (Esterification Degree/Esterifying Agent) × 100

As can be seen from the above results, in Examples of the present invention in which the vinyl esters were used as the esterifying agent, the reaction rate was more improved as compared with Comparative Example 1 in which methyl acetate was used as the esterifying agent.

### INDUSTRIAL APPLICABILITY

According to the present invention, it is possible to provide a method for esterification of a polyvinyl alcohol-based resin, which can esterify the polyvinyl alcohol-based resin at a high reaction rate under mild reaction conditions using relatively simple reaction equipment, and is also applicable to polyvinyl alcohol-based resins as raw materials without being restricted by polymerization and saponification degrees thereof. According to the present invention, it is also possible to provide a modified polyvinyl alcohol-based resin excellent in physical properties such as polymerization and modification degrees, which is applicable to various applications.

1. A method for esterification of a polyvinyl alcohol-based resin by an esterification reaction using an esterifying agent, wherein a vinyl ester is used as the esterifying agent.

2. The method for esterification of a polyvinyl alcohol-based resin according to claim 1, wherein an aprotic polar solvent is used as a solvent in the reaction.

3. The method for esterification of a polyvinyl alcohol-based resin according to claim 2, wherein the polyvinyl alcohol-based resin is completely dissolved in the aprotic polar solvent in the reaction.

4. The method for esterification of a polyvinyl alcohol-based resin according to claim 1, wherein an alkali metal compound is used as an esterifying catalyst in the reaction.

5. The method for esterification of a polyvinyl alcohol-based resin according to claim 1, wherein sodium acetate which is preliminarily contained in the polyvinyl alcohol-based resin is used as an esterifying catalyst in the reaction.

6. A modified polyvinyl alcohol-based resin obtained by the esterification method according to claim 1.

7. A method for production of a modified polyvinyl alcohol-based resin from a polyvinyl alcohol-based resin by an esterification reaction using an esterifying agent, wherein a vinyl ester is used as the esterifying agent.
